(19) United States
(12) Patent Application Publication
(10) Pub. No.: US 2013/0318872 A1
(43) Pub. Date: Dec. 5, 2013

(54) PLANT POT ASSEMBLY

(71) Applicant: PATENTSTAR B.V., Boskoop (NL)

(72) Inventor: Bart van der Starre, Waddinxveen (NL)

(73) Assignee: Patentstar B.V., Boskoop (NL)

(21) Appl. No.: 13/794,905

(22) Filed: Mar. 12, 2013

(30) Foreign Application Priority Data
Jun. 1, 2012 (EP) 12170611.3
Jun. 1, 2012 (NL) 2008923
Dec. 3, 2012 (EP) 12195336.8

(51) Int. Cl. A01G 27/06; A01G 9/02

(52) U.S. Cl. CPC A01G 27/06; A01G 9/02
USPC 47/66.6; 47/81

(57) ABSTRACT

A plant pot assembly comprises a first pot for a plant in growing medium, a second pot coupled to it for forming a liquid reservoir, and a wick between the liquid reservoir and the first pot for transporting liquid from the liquid reservoir into the first pot. The liquid reservoir has a filling opening at or near the upper side of the assembly and wherein the first pot is received in the second pot with a close fit so that the liquid reservoir is situated substantially below the first pot. The wick extends between the first and second pots and protrudes near an upper edge of the first pot into the first pot, and extends in it. The first pot is substantially watertight and the assembly is arranged to prevent liquid transport between the reservoir and the growing medium via another route than the wick.

### PRIORITY CLAIM(S) AND/OR CROSS REFERENCE(S) TO RELATED APPLICATION(S)

This application is an original application under 35 U.S.C. §111(a) claiming priority to Dutch Application No. 2008923, filed Jun. 1, 2012, European Application No. 12170611.3, filed Jun. 1, 2012 and European Application No. 12195336.8, filed Dec. 3, 2012, which applications and publications are incorporated herein by reference and made a part hereof in its entirety, and the benefit of priority of which is claimed herein.

### TECHNICAL FIELD

The present disclosure relates to a plant pot assembly. The assembly comprises a first pot with an interior space for receiving therein a plant in soil or in another growing medium and a liquid reservoir coupled to it. The assembly further comprises a wick which extends from the liquid reservoir to inside the interior space of the first pot for transporting liquid from the liquid reservoir into the first pot. An aspect relates to a plant pot assembly which comprises a pot and a carrier. The underside of the pot is provided with one or more positioning structures for cooperation with a suitable carrier. The invention further relates.

### BACKGROUND

Plant pot assemblies for providing liquid, in particular water, to plants growing in the growing medium more or less automatically for prolonged periods without it being required to water the plants regularly are known.

For instance, from FR 2 814 639 an arrangement is known for providing a controlled irrigation of plant pots. The arrangement comprises an external container in which in a centre an internal container with a smaller diameter is arranged which is insulated from the outer container. The plant is irrigated by flowing water from the intermediate space between the two containers by means of a covered wick of which the flow is regulated with a screw stop.

U.S. Pat. No. 4,999,947 describes a comparable arrangement.

U.S. Pat. No. 4,741,125 describes a wick-based liquid delivery system for plants. The system includes a chamber for the storage of liquid and a wick which is rigidly supported in a tube in the shape of an inverted U. The system is also equipped with an adjustable moisture-sensitive brake mechanism for regulating the flow of liquid.

These systems are quite complex and therefore they are expensive and vulnerable.

Simpler systems are known as well. E.g., EP 0 688 497 describes a flower pot which is fixed with respect to an outer container by a lid plate. Between the flower pot and the container is water. A wick extends in the water and through the bottom of the flower pot for thus wetting soil in the flower pot.

U.S. Pat. No. 4,250,665, U.S. Pat. No. 4,339,891, U.S. Pat. No. 5,081,790, WO 2009/030019 and GB 2 444 141 also describe, for instance, assemblies of flower pots and reservoirs, wherein a water reservoir is arranged underneath the flower pot, and wherein a wick extends in the water of the reservoir and through the bottom of the flower pot for thus wetting the soil in the flower pot. U.S. Pat. No. 4,250,665 further describes an embodiment (FIG. 4) wherein the opening for the wick is located in the upper portion of the sidewall of the flower pot to permit a higher level of liquid in the liquid reservoir. DE 24 09 714 and DE 24 26 582 disclose a similar plant pot with liquid storage for prolonged provision of liquid.

DE 103 433 also describes a flower pot with self-humidification, wherein a reservoir is fixed under a plant pot and humidification of the soil occurs from the reservoir via wicks. The wicks extend in a recess of the pot wall and are held therein by a wedge of disinfectant and fertile material. The reservoir is filled by watering the soil from above and collecting the water that is not absorbed by the soil. A similar device for cultivating at least one plant is disclosed in CH 342027.

Also noted is CN 201726722, which discloses a water-saving passive automatic watering device. The watering device comprises an inner sleeve and an outer sleeve respectively with micropore surface; the bottoms of the inner sleeve and the outer sleeve are connected in sealing manner to form a water storage bin; a capillary tube is arranged between the inner sleeve and the outer sleeve; and the capillary tube is a capillary fiber tube; a water injection port is fixedly arranged on the top of the water storage bin.

For production, transport and displaying plants, an assembly of a plant pot and a carrier may be provided. In such case the carrier can be used to determine an arrangement of the pots.

WO 2004/095905 discloses, e.g., plant pots and a multi-component tray. The pots and tray have a self-orienting configuration for urging the pots into proper alignment when same are placed within compartments of the tray. The pots include angled holes disposed radially about the bottom portion of the pots. The compartments of the tray include angled protrusions disposed radially about the bottom portion of the compartment. The angled holes of the pot engage with the angled protrusions of the compartment when the pot is placed in the compartment to urge the pot into proper alignment. A plurality of slots are included along an upper portion of each pot for allowing optional identification tags to be inserted thereinto. The identification tags, in addition to logos, artwork, or other indicia, if included, are positioned by the self-orienting configuration of the pots and tray to face in a desired direction.

Such pots and trays can provide a uniform presentation but the assembly has the drawback that relatively complex moulds are needed and much material is used. Moreover, the pot and tray are relatively fragile because of sharp corners and they prove not to work well, in particular when dirt and/or other contaminants has (have) entered between the pot and the tray, wherein amongst others the pots remain standing relatively high, uneven and unstable in the tray.

Further, U.S. Pat. No. 5,022,183 is known which provides a tray for retaining a flower pot having a pot bottom with drain holes. The tray has a planar bottom wall for supporting the pot bottom and restrains the pot from moving parallel to the plane of the tray bottom wall. A protrusion is formed in the tray bottom wall in registration with a pot drain hole. The protrusion has a transverse lip adapted to overlie the pot bottom and restrain transverse movement relative to the plane of the tray bottom wall.

JP 11-285315 further provides a plant pot having crossing grooves in the bottom to be attached to a crossing of rod-shaped carriers.

Such assemblies according to U.S. Pat. No. 5,022,183 and JP 11-285315 complicate placement of the pots in and on, respectively, the carrier and prevent in particular removal and putting back the pots from the carrier which renders the assemblies unsuited for sale displays.

### SUMMARY

It has appeared to the inventors that the known systems described above do not satisfy the demands of growers and sellers, e.g. with respect to lifespan, in particular during transport and/or (shop) storage, plant growth, root growth, transportability and/or the amount of care of the plants required. Similar holds for a display comprising the plants. Therefore a demand for improvements exists.

Herewith an assembly according to the appended claims is provided. The liquid reservoir is arranged such that the reservoir is situated substantially below the first pot, at least substantially below the interior space thereof, and is connected with the filling opening via a filling channel, wherein the wick protrudes along or near an upper edge of the first pot into the interior space of the first pot, and wherein the first pot is watertight such that the assembly is arranged to prevent water transport between the reservoir and the growing medium via another route than the wick.

In the assembly, in the interior space of the first pot a plant in a growing medium, in particular soil, may be placed and may be provided through the wick with liquid, in particular water. Since the wick protrudes along or close to an upper edge of the first pot into the interior space of the first pot and extends from there in the interior space a homogeneous humidity distribution over the growing medium is provided. For it has been found that wetting the medium, in particular soil, from the bottom thereof can lead to an inhomogeneous distribution of humidity over the medium, with a too dry upper side and a too wet lower side. Due to this, nutrients cannot be drawn optimally from the growing medium and root growth can lag and therewith growth of the plant as a whole can lag.

The wick may be arranged in the interior space of the first pot in an upper portion, e.g. an upper half or upper quarter, in particular above the roots of a plant in the interior space, wherein further transport of the liquid through the growing medium may be provided by the growing medium itself. Also with this a suitable liquid distribution in the growing medium may be achieved. Thus, it is possible to save on wick material. Also providing the wick and/or planting the plant may be facilitated.

Further it has appeared that by wetting along the underside of the plant pot an increased risk exists of excessive water supply so that the plant roots may rot. Since in the assembly provided herewith liquid transport, e.g. water transport, between the reservoir and the growing medium is prevented outside of the wick, such rotting and drowning of the plant roots can be prevented.

It has also been found that one or more openings in an under side of the first pot may further lead to leaking of liquid from the pot into the reservoir leading to a too dry soil, leaching and loss of nutrients from the soil, and/or contaminating (contents of) the reservoir.

Since the reservoir is situated below the interior space of the first pot it is prevented that, as in communicating vessels, by fluid pressure and by siphoning action of the wick, a liquid level is established in the reservoir and in the first pot above the bottom of the first pot that is too high for the plant roots and that can drown them. A provision for regulating and/or limiting a liquid flow or flow rate through the wick can therefore be left out.

The assembly is transportable as a whole due to the coupled first and second containers. A fully or partly liquid filled reservoir can lower the centre of gravity of an assembly that is provided with one or more plants and a growing medium, so that the assembly becomes more stable and the risk of it toppling and/or falling over can be reduced.

Transport is further simplified and stability is increased since the first pot is received in the second pot.

Moreover, the wick extending between the pots facilitates maintenance of a proper atmosphere around the wick, e.g. preventing drying out of the wick and/or preventing algae growth on or in the wick. It also facilitates accessing the wick for control and/or exchange by removal of the first and second pots from each other and thereby exposing the wick.

The first and second pots may be releasably coupled, e.g. for exchange of the first and/or second pot, for cleaning the reservoir etc.

In addition, the first and second pots are coupled by fitting close together upon coupling, e.g. with a tight fit, and they may be coupled by being provided with a closure, cooperating coupling means such as hooks and eyes and/or a lid, so that the pots can be coupled tightly and undesired separation from each other is prevented or at least complicated. Thus, evaporation of the liquid from the reservoir may be prevented as well.

The first pot has a substantially watertight wall, so that evaporation of the liquid from the reservoir is reduced or prevented and so that undesired transport from the reservoir other than via the wick is prevented. It also facilitates maintenance of a proper humidity of the growing medium.

The reservoir is provided with a (re)filling aperture, which may be closable, so that the liquid level may be replenished. Closability may counter loss of liquid through evaporation. A filling opening at or near the upper side of the assembly facilitates filling the reservoir. It also facilitates wetting the wick in a channel between the first and second pots through which the wick extends and which is in fluid communication with the filling channel.

The assembly may be arranged to give a signal to a user when the reservoir is filled over a particular level. E.g., a window may be arranged in the reservoir. Also, a float may be provided with a signalling means, e.g. a pen protruding from the filling opening on overfilling. An electric signalling system may also be provided. Further it is possible that the first pot is movably coupled with the second pot and functions as a float and starts to float in the second pot with excess filling.

In an embodiment the wick protrudes into the interior space of the first pot through an opening in a wall of the first pot near an upper edge of the first pot, e.g. a few centimetres below an upper edge, such as between 0.5 and 5 cm from it, preferably between 1 and 3 cm. Due to this the wick may be fully covered with the growing medium and thus be remain substantially invisible. Further, evaporation of the transported liquid from the wick is prevented.

A plant is cultivated in a cultivating pot. This needs holes to allow administration of water and nutrients to the plant. It is beneficial if the assembly is realised such that the first pot of the assembly is substantially of equal shape to the cultivating pot in which the plant that is to be transported and/or sold is or has been cultivated. In that case the plant can be repotted without requiring to reduce the size of the soil block or to add extra growing medium (e.g. soil). The cultivating pot can then be reused.

The first pot and the cultivating pot may for instance be made with substantially the same techniques and/or machines, e.g. via injection moulding. A mould for that may be provided with plugs or presses etc. for defining holes in the cultivation pot, and wherein for forming of the first pot the corresponding plugs, stamps, etc. are removed from the mould, so that otherwise substantially identical pots are formed.

It is possible to offer the assembly together with a cultivating pot, so that a packet is formed for cultivation and subsequent sale.

The assembly may comprise growing material and a plant, wherein the reservoir is arranged to contain sufficient liquid and possibly nutrients and/or dunging substances to let the plant survive a particular period, e.g. one, two or three weeks or a month. The period is preferably calculated to a customary period for transport from a grower to the moment of sale to a consumer.

The first pot and in particular the second pot may comprise an ornamental pot. The first and/or second pot may be formed stackable for place- and volume-efficient empty transport.

The assembly may be formed such that the outer sizes of the assembly correspond to standard sizes, e.g. for dense filling of a level of a so-called “Danish cart”, which is the de facto standard transporting means for the professional plant growing industry. To that end the first and/or second pot may have a substantially rectangular upper side in cross section, possibly combined with a bottom side that is substantially rounded, e.g. elliptical in cross section.

The assembly provide herewith may be manufactured cost-efficient, in particular than the systems described hereinbefore. Further, the costs in use of the provided assembly may be reduced for transport and/or storage, in particular since attention to and/or (time for) care of the plant may be reduced and/or be required less, what may benefit the condition of the plant and/or its survival. Thus, plants may fare better in surroundings wherein time for and/or knowledge of plant care are limited for shorter or longer periods, e.g. in supermarkets, home improvement stores and/or in consumers homes. Thus, loss costs for wholesale and/or retail may be reduced and for consumers satisfaction and enjoyment may be increased and/or extended.

In an aspect, an assembly of a pot and a carrier are provided. The pot may in particular be a pot of a pot assembly as described hereinbefore. The pot and carrier comprise cooperating first and second positioning structures to, in assembled state, define a single relative orientation of the pot and carrier. Thus, a shape-lock is provided that breaks rotational symmetry such that placement of the pot on the carrier is uniquely defined. In such manner a desired presentation of the assembly may easily be guaranteed.

If the carrier comprises a plurality of positioning structures to define in plural relative positions a single relative orientation of the pot and the carrier, a same presentation can be achieved in different positions of the pot relative to the carrier.

In particular the assembly of pot and carrier comprises a plurality of pots, preferably identical pots, wherein, in assembled state of the carrier and pots, the positioning structures define the same relative orientation of the respective pot and the carrier.

In an embodiment the pot is round shaped and it may have a cylindrical or (truncated) conical shape. Such a shape is customary and beneficial during (automated) growing and logistics and it is generally considered attractive. A (sales-) display with identical round pots as expounded herein can efficiently have a uniform and therewith pleasingly well-organized and consumer interest exciting appearance.

In another embodiment each pot has a top side, wherein the top side has an non-circular shape in top view. The bottom side can then have a round shape in cross section. The non-circular shape may e.g. be oval or drop-shaped, but also rectangular or triangular. Due to the non-circular shape of the pot the uniformity of the display is stressed and the consumer interest exciting potential of the display is increased. By a round bottom side an, at least apparently, slender shape may be provided and the uniformity of the presentation of the top sides may be stressed extra. An oval or drop-shaped top side provides an organic non-circular shape with a pleasing appearance, which readily appears larger than it is.

Due to the fixed relative orientation labels, support elements and/or decorations, etc., may be easily arranged in equal positions in a display. Namely, it has been found that the presentation of plant pots in a display has a pronounced effect on the interest and willingness to buy of potential consumers, wherein a uniform presentation clearly increases the consumer interest exciting potential of the display. In a display wherein the pot or pots is or are provided with a plant placed in the pot, possibly in a growing medium, this is in particular the case because since due to the natural diversity of the plants already a somewhat inquiet display is provided.

In a uniform presentation of pots provided with plants the focus of the display may lie more on the plants themselves, which thereby can also appear larger and more attractive. Further, the orientation of the pot on the carrier may be taken into account when arranging a plant in the pot so as to provide an attractive presentation of the plant.

By the cooperating positioning structures it is also ensured that a pot that possibly is removed from the carrier is placed back in another orientation, e.g. during refilling of a display or by customers. Thus supervision of the display may also be reduced.

Preferably the first and second positioning structures extend in a vertical direction in normal use, that is, upward for the pot and vertical for the carrier which otherwise extends horizontal. In particular the first positioning structure comprises a hole, in particular one or more holes with a non-circular shape, and the second positioning structure comprises one or more protrusions to be received at least partly in the hole(s). Preferably, the bottom of the pot is provided with the hole(s), typically in the shape of a cavity, and the carrier is provided with one or more protrusions.

A vertical orientation of the positioning structures simplifies use by simply placing the pot on the carrier. This also facilitates keeping pots accessible in a close arrangement. A hole in the bottom of the pot can readily maintain stability of the pot. Further, a positioning structure in the bottom of the pot can (also) be provided such that it is at least invisible when the pot is placed on a flat surface without use of the carrier, in particular when the hole is provided as a local cavity or depression at or near the centre of the bottom. Thus, the pot can be provided as decorative pot. A cavity in the bottom of the pot can be used to increase an apparent volume of the pot relative to the actual volume to provide, by which in a relatively large pot with relatively little soil or other growing medium a relatively high filling height may be provided.

The one or more holes and/or the one or more protrusions may be formed at least partly conic with upwardly deceasing size, so that a self-seeking effect can be achieved which simplifies placement and use. This may further facilitate manufacturing and/or stacking of a number of pots and/or carriers, e.g. by a clearing effect from a mould in a product that is cast or manufactured by deformation of a flat(-ter) initial material.

Placement of the pot on the carrier in the desired orientation is further ensured in case the one or more holes and one or more protrusions are formed such that a protrusion van only be inserted into a hole only in the single defined relative orientation of the pot and the carrier. E.g. the protrusion has a non-circular shape in cross section and a corresponding hole has a matching non-circular shaped entrance opening. Also in such case the first and second positioning structures can be formed such that in the defined single relative orientation an easy-entry portion is provided, e.g. due to an upwardly size decreasing conic portion, so that a self-seeking effect is provided.

A strong construction is provided when the first and second cooperating positioning structures have a corresponding shape, so that the walls of the positioning structures can at least partly support each other. Further it is thus clarified more clearly that the pot and carrier form an assembly of matching parts.

A stable position of the pot and carrier is important for transport, in particular in case of high and/or top-heavy realisation such as in combination with one or more high and/or heavy plants. The positioning structures assist with that. An important benefit is that further the cooperating positioning structures help prevent falling over of the plant pot during cultivation, logistics and/or in a (sales) display, e.g. due to movement of a support or a table, a gust of wind and/or clumsily placing a pot etc. In a traditional dense arrangement of plural pots, falling over of a single pot, in particular when provided with a plant, can lead to falling over of further adjacently placed pots, as in the well known “domino-effect”. Apart from damage to the display as such this may also cause damage to and/or loss of plants and/or pots. Such damage is reduced or even prevented by the present assembly.

The carrier may have a plane shape, apart from the positioning structures, e.g. a shelf, a cultivation table, a conveyor belt, a board, for long and/or short during placement. A carrier may also be formed as a so-called “tray”, for carrying a number of pots.

In a particular embodiment the carrier has a space for at least partly receiving and supporting the pot therein, wherein the carrier space comprises one of the first and second positioning structures. Preferably, the carrier comprises more carrier spaces for receiving therein more pots. The carrier hole(s) may at least partly fit closely about the respective pot(s) in an assembled state. This further provides a fortified assembly.

One of the first and second positioning structures may be arranged in the carrier hole; in particular one or more protrusions may be arranged in the carrier hole, preferably one protrusion per hole, e.g. at or near a centre of the hole, wherein the carrier hole has a top side and a depth with respect to that, and at least one of the protrusions extends up to the top side of the hole or near that. Thus, the protrusion may be clearly visible and the chance that the pot is placed in the carrier in a wrong orientation is reduced or even prevented, in particular when the protrusion has a clearly visible non-circular shape. In particular when the pot has a hole and the respective protrusion is shaped such that they can only be inserted into each other only in the one predetermined relative orientation of the pot and the carrier, placement of the pot in the carrier in a wrong orientation may be prevented or precluded. These effects are further increased when the protrusion(s) extend(s) above the top side of the carrier holes.

When the top side of the pot, the top side of the protrusion and the entry opening of the hole are formed equally non-circular it readily becomes apparent what the predetermined relative orientation is and it is prevented that erroneous placement of the pot on or in the carrier in a wrong orientation is attempted. This reduces (chances of) wrong placement, forcing, wear, damage of the objects and/or irritation of users.

The assembly of pot and carrier may be formed such that the outer dimensions of the assembly correspond with whole fractions of standard sizes, e.g. for close filling with a number of assemblies of a Euro-pallet and/or a level of a so-called “Danish Cart”, what are de facto standard transporting means for professional plant cultivation.

The assembly of pot and carrier further simplifies determination of stocks, since the pots are placed regularly and positioning structures without pots are (more) clearly recognisable.

The assembly provided herewith may be manufactured cost-efficient. Further, costs of use of the provided assembly in transport and/or stock maintenance can be reduced, in particular since attention for and/or (time for) placement and/or (re-)orientation of the pot may be reduced. Thus an attractive display may be provided and/or maintained easily.

### BRIEF DESCRIPTION OF THE DRAWINGS

The above-described will hereafter be more explained with reference to the drawings, in which

FIG. 1 shows a first embodiment in cross section;

FIG. 2A shows a second embodiment in cross section; and

FIG. 2B is a top view of the embodiment of FIG. 2A, with the cross section plane of FIG. 2A indicated;

FIGS. 2C-2D show a further embodiment in cross section and top view like FIGS. 2A-2B, and FIG. 2E shows this embodiment in rear view;

FIGS. 3A-3C show another embodiment, in perspective view, top view and cross section according to line C in FIG. 3B, respectively;

FIGS. 4 and 5 show arrangements of a number of assemblies according to FIGS. 3A-3C; and

FIGS. 6A-6C show a further embodiment of an assembly.

FIG. 7 shows an assembly of pots and a carrier in perspective;

FIG. 7A shows the assembly of FIG. 7 in top view;

FIGS. 8A-8B show the carrier of FIG. 7 in perspective from above respectively from below;

FIGS. 9A-9C are views of the pot 103 of FIG. 7;

FIG. 10 shows a cross section of the assembly of FIG. 1 according to line X in FIGS. 7 and 7A;

FIG. 11 shows a positioning cam for manufacturing of a carrier for an embodiment of an assembly.

### DETAILED DESCRIPTION OF EMBODIMENTS

It is noted that the drawings are schematic, not necessarily to scale and that details that are not required for understanding the present invention may have been omitted. Like elements may be denoted by the same numeral.

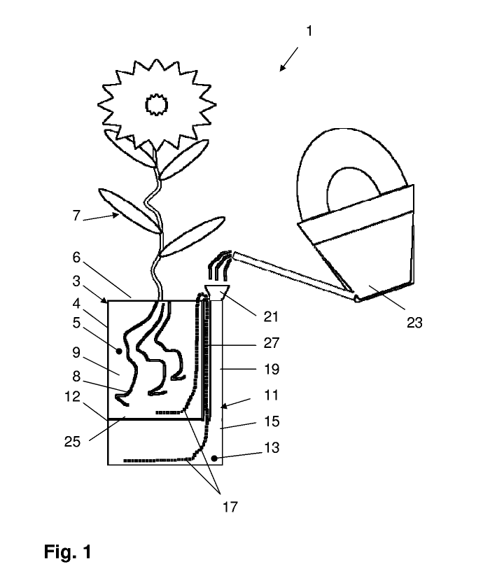

FIG. 1 shows a plant pot assembly 1, comprising a first pot 3 with a perimeter wall 4 which surrounds an interior space 5 with an upper rim 6 and in which a plant 7 with roots 8 in soil 9 is received. The assembly further comprises a second pot 11 with a wall 12 and an interior space 13 by which a liquid reservoir 15 is formed, and a wick 17.

The second pot 11 comprises a filling tube 19 which extends along the first pot 3 and which is provided with closable opening 21, so that the reservoir 15 may be filled, e.g. with the aid of a watering can 23. A filling opening 21 for the reservoir 15 that is positioned at or near an upper rim of the first pot 3 facilitates filling the reservoir 15. It also stresses filling the reservoir instead of watering (the soil of) the first pot 3, which reduces chances of improper use of the assembly and drowning of the plant.

Since the plant 7 is in an enclosed pot, watering the plant should be done only via the reservoir, since the risk of drowning the plant becomes large otherwise.

The first pot 3 and the second pot 11 are fixedly coupled together. The reservoir 15 is situated below the first pot 3 and is separated from it by means of a liquid tight, in particular water tight, bottom 25 of the first pot 3. The liquid level 15 is thus arranged to maintain the liquid level of the liquid received therein substantially below the bottom 25 of the first pot 3.

The wick 17 protrudes into the liquid reservoir 15 and extends from there outside (the perimeter wall 4 around) the interior space 5 of the first pot 3 but protrudes along and over the upper edge 6 into the interior space 5. The wick 17 further extends through at least a portion of the growing medium 9.

In this embodiment the wick 17 extends through a specially provided channel 27 between the first pot 3 and (the filling tube 19 of) the second pot 11.

The filling tube 19 extends aside the interior space 5 of the first pot 3. Due to this, water pressure might occur on the wick 17 which might cause a surplus of liquid in the soil 9 through siphoning of the wick 17. To prevent excess wetting, the filling tube 19 is formed such that the interior volume of the filling tube 19 is small to negligible with respect to the rest of the volume of the first pot 3. Further, a closing lid and/or signalling may be provided which assists preventing filling of the reservoir 15 with a liquid level above the bottom of the first pot 3. A small volume of the filing tube 19 further provides a safety against overfilling the assembly since, during filling, the tube may give “clucking”-sounds, the tone of which being related to the level of the liquid level in the tube.

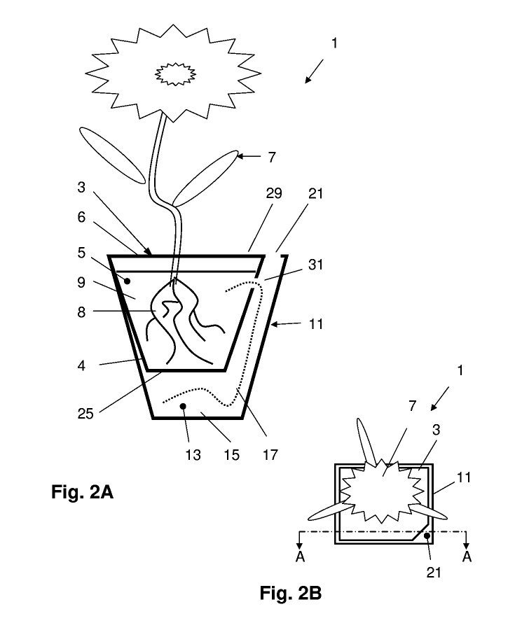

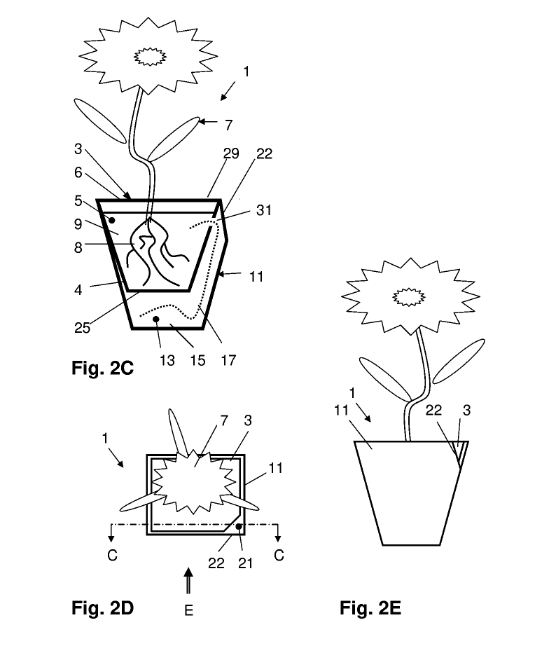

FIGS. 2A and 2B show another embodiment, wherein the first pot 3 is substantially fully received in the second pot 11, so that the upper edge 6 of the first pot is substantially flush with the upper edge 29 of the second pot 11. This provides a pleasant appearance. The reservoir 15 is formed, in this embodiment, between the bottoms and walls of the first and second pots 3, 11. Here, the wick 17 extends between the pots 3, 11 and protrudes into the interior space 5 of the first pot 3 through an opening 31 in the side wall 4 of the first pot 3. The opening 31 is invisibly covered by the growing medium 9. The portion of the wick 17 that protrudes into the first pot 3 is relatively short and extends only in an upper portion of the first pot 3, wherein the wick 17 remains substantially above the roots 8 of the plant 7.

The reservoir 15 may be filled through filling opening 21, with provides direct access to the interior space 13 of the second pot 11. Here, the opening 21 is defined by the cooperating shapes of the first and second pots 3, 11, wherein here the first pot has a bevelled edge of an otherwise rectangular shape in top view, see FIG. 2B, but other shapes, like a spout or a funnel and the like are also possible. A benefit of the shape of FIG. 2B is that a close filling of a surface is facilitated. Further, the shape of the first pot comparable to that of a cultivating pot.

FIGS. 2C-2E show a variant of the embodiment of FIGS. 2A-2B in cross section (FIG. 2C), top view (FIG. 2D) and rear view (FIG. 2E), respectively, wherein the filling opening 21 is enlarged and (rim 22 of the filling opening 21) is lowered by, relative to the embodiment of FIGS. 2A-2B, removing a corner of the second pot 11. The position of the bottom of (the rim 22 of) the filling opening 21 is preferably chosen to limit a maximum filling level in the reservoir at a level below the wick opening 31. However, the level is preferably chosen such that the risk for spilling water from the reservoir during filling and in particular during transport in filled state is small.

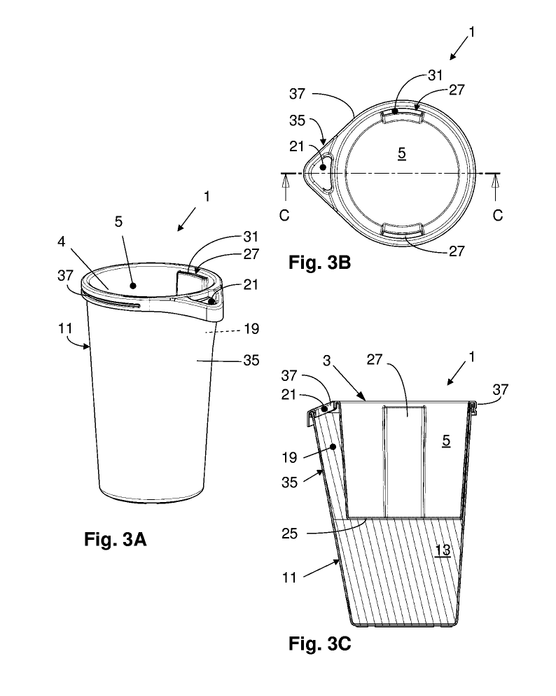

FIGS. 3A-3C show a further embodiment of an assembly 1. The first pot 3 is substantially round in top view. The second pot 11 is also substantially round, but is provided with a funnel 35 which forms a filling channel 19 with a filling opening 21 at the upper side of the assembly 1. The assembly 1 provides two channels 27 with openings 31 to the interior of the first pot 3 for a wick (not shown). A plurality of wicks facilitates increased and/or symmetric humidification of the soil. The side walls of the first and second pots lie close each other to reduce the volume between the side walls as much as possible. The first pot 3 has an upper rim 37 which grips around the upper rim of the second pot 11, here with an inwardly dented lip around a thickened portion of the upper rim, so that a fixed coupling, here a snap coupling, is formed which prevents sudden loosening and such that a simply transportable unit is formed. The upper rim 37 of the first pot 3 grips around the entire upper rim of the second pot 11 so that a unit is formed which increases hygiene and has a pleasing appearance. An opening in the upper rim 37 of the first pot 3 defines the filling opening 21.

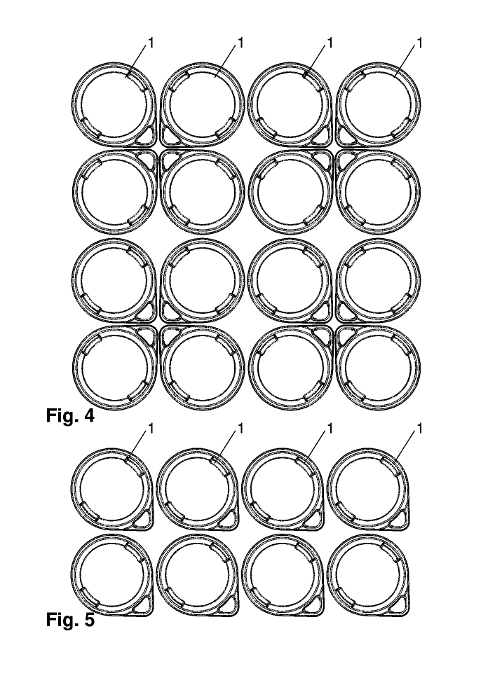

Best visible in FIG. 4 is that the assembly 1 is substantially round in top view with a funnel 35, such that a drop-shape in top view is provided, with a relatively sharp side formed by the funnel 35 and a relatively blunt side by the round basic shape. The funnel 35 of the assembly fits, at the relatively sharp side, within a circumscribed rectangle, here a circumscribed square, around the blunt side. Thus, the assembly is formed such that a regular close arrangement of a number of assemblies 1 is possible, here in a square arrangement, see FIG. 4. A triangular or hexagonal basic shape is also possible and suitable. In another arrangement (FIG. 5) the assemblies can be arranged substantially identically, which provides an attractive uniform appearance.

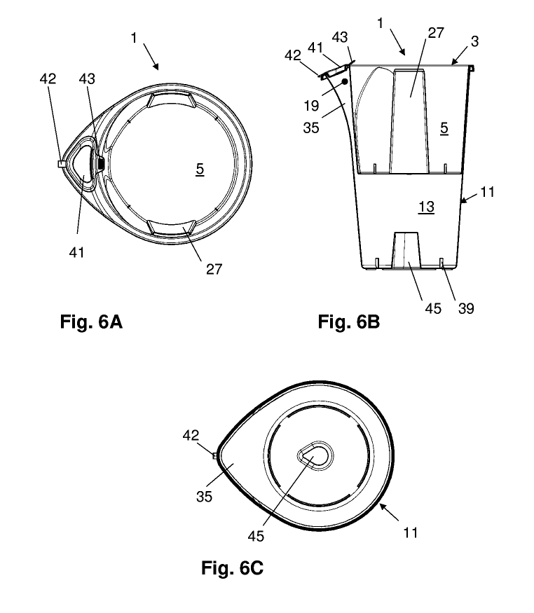

FIGS. 6A-6C show a further improved variant of an assembly 1, in top view (FIG. 6A), cross section (FIG. 6B) and bottom view (FIG. 6C). Here, the wall of the funnel 35 between the filling opening 21 and the bottom of the inner pot 3 is bent inward with respect to the embodiment of FIGS. 3A-3C, towards the inner pot 3 (best visible in FIG. 6B), so that the volume of the filling channel 19 and therefore the intermediate volume in between the side walls of the inner pot 3 and the outer pot 11 is reduced further. Further, the side walls of the first and second pots 3, 11 closely fit to each other whereby they touch each other over the major part of their surfaces, preferably substantially over their entire surface except for the portions of the filling channel 19 and the wick channels 27, to minimise the volume between the side walls of the pots 3, 11.

The opening 21 of the funnel 35 is closed in this embodiment against leaking and evaporation with a lid 41, which may be attached to the first or second pot 3, 11 against loss, e.g. by means of a film hinge 42 such as here. In the shown embodiment the lid 41 is provided with pulling lip 43 for simple opening, wherein here, the pulling lip 43 is oriented towards the middle of the assembly and thus stays within the perimeter of the second pot 11. In the embodiment of FIGS. 6A-6C the outer pot 11 is provided with a number of optional cams 39 that facilitate a stable stacking of a number of pots 11. In the inner pot 3 the channels 27 for the wicks extend somewhat tapered upward to facilitate fabrication and a stable stacking.

To facilitate obtaining a suitable arrangement, e.g. for a display according to FIGS. 4 and/or 5, the bottom side of the second pot is provided with one or more optional positioning structures for cooperation with (structures of) a suitable carrier (see below). Here, a recess forming a shape lock 45 is provided that breaks rotational symmetry of the pot 11 and in this embodiment comprises a recess in the bottom 46 of the pot 11 with an noncircular shape, that can cooperate with one or more suitably formed protrusions of a carrier to define a particular relative position and/or orientation (see below). Here, the shape lock 45 is provided conically such that a self-seeking effect to the desired position may be achieved, and which facilitates manufacturing and/or stacking of a number of pots 11.

Due to a slender shape of the assembly, the connection between the first and second pots and/or at least substantially fully accommodating the first pot in the second pot, an attractive assembly may be provided. In embodiments with a relatively high outer wall of the second pot relative to the bottom of the first pot and the upper side of the reservoir, e.g. wherein the first pot is received substantially fully in the second pot and the upper rims of the first and second pots are arranged at similar levels, spilling of water during transport may be prevented. Due to a substantially straight or conical shape of the first and second pots 3, 11 which flares toward the upper side the pots 3, 11 can easily be placed in each other with a close fit, so that a reservoir volume between both pots and above the bottom of the first pot 3 is reduced or even prevented as much as possible, which otherwise could lead to excessive water supply to the plants.

In embodiments wherein the first pot is received substantially or entirely in the second pot, the wall of the second pot 11 forms a protection for and reinforcement of (the wall of) the first pot 3 so that further a robust assembly may be provided with a relatively thin wall of the first pot 3, which saves material. In particular in an assembly 1 wherein the first pot 3 is coupled with the second pot 11 by a tight fit and the walls of the pots 3, 11 touch each other at least partly and support each other, e.g. to couple the first and second pots and/or to minimise the reservoir volume above the bottom of the first pot, a portion of the second pot 11 can also be provided relatively thin.

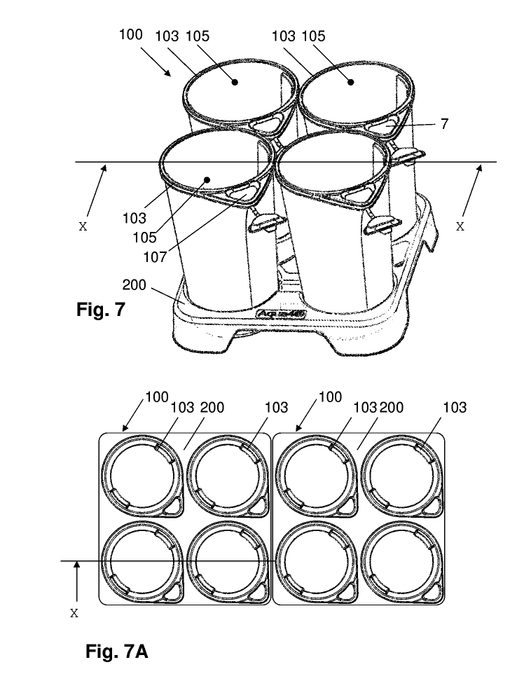

Exemplary values for suitably dimensions of the model shown in FIGS. 7A-7C are: volume first pot, ca. 1 litre (e.g. ca. 11 cm diameter×10 cm height); volume reservoir in the second pot below the bottom of the first pot ca. 0.75 litre, wick channels ca. 3×0.3 cm for wicks of ca. 2.5-3×0.2 cm; residual volume between first and second pots (filling tube, wick channels, other intermediate spaces) ca. 50 ml or less, e.g. in a preferred embodiment less than ca. 35 ml. This residual volume is, in use, reduced by the volume taken up by the wick(s), typically about 5-10 ml. The residual volume, which thus is less than about 3% of the volume of the first pot, is, in use, not fully filled with liquid (water) to prevent overflowing and/or spilling, and to provide at most a negligible amount of water in the residual volume between the side walls of the pots relative to the volume of the first pot, which can be used in a short time span by the plant so that the fluid level in the reservoir is located further below the bottom of the first pot. An assembly with such dimensions proves to keep a water-loving plant like a hortensia in good condition without requiring further care. A relatively drought-loving plant such as a cactus stays in good condition much longer.

FIGS. 7, 9 and 10 show an assembly 100 comprising a carrier 200 and a number of substantially identical pots 103 in it. The carrier 200 is shown in FIG. 2. The shown pot 103 is substantially similar to the pot assembly 1 of FIGS. 6A-6C. Each pot 103 has an interior space 105 for receiving therein a plant in soil or another growing medium (not shown). Each pot 103 further has a bottom side with a substantially round shape and a top side with a non-circular shape in top view, here a drop-shape with a spout 107 (see below).

The carrier 200, or tray, has a substantially rectangular, in particular square, shape for close filling of a rectangular surface and it extends in normal use as shown in FIG. 7 substantially horizontally. The carrier 200 has a top wall 209, side walls 211 and a number of recessed holes in the top wall 209 that form cavities 213 in the carrier 200 with walls 215 and bottoms 217. In each carrier space 213 near the centre of the bottom 217 a positioning structure 219 is provided in the form of a conic protrusion with a non-circular shape in top view, which may be generally round nevertheless. Here, the protrusion 219 has a drop shape with a relatively acute side and a relatively obtuse side so that a somewhat elongated shape with a relatively large length and a relatively short width is provided. The protrusions 219 protrude substantially vertical upward from the bottom 217 so that they protrude above the top wall 209 and the top side of the cavity 213. In the shown carrier 200 the protrusions 219 are all directed in the same relative orientation of the carrier 200, namely with the acute side and length arranged substantially parallel to a (main) diagonal of the carrier 200. The constant top angle of the cone is chosen such that the width of the protrusion 219 near the bottom 217 is smaller than the length of the top side of the protrusion 219.

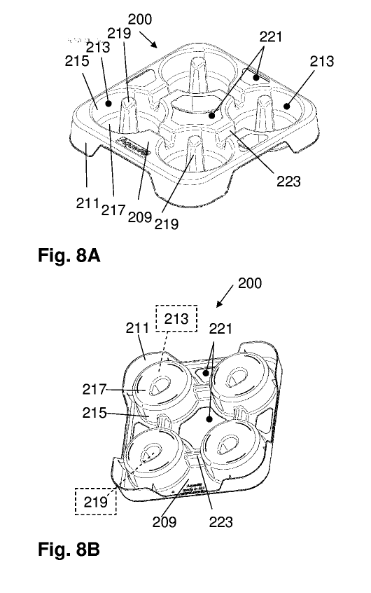

The carrier 200 may rest on a substantially plane subsurface on bottom edges of the side walls 211 and the under sides of the bottoms 217, so that the top wall 209 is supported by the (side) walls 211, 215, and the protrusions 219 extend vertically upward. The carrier is formed substantially hollow which saves material and weight (cf. FIG. 8B). In the top wall 209 of the carrier optional apertures 221 are provided to save further material, likewise, the side walls 211 are restricted mainly to parts near the corners of the carrier 200. Ribs 223 are further provided for stiffening the carrier. Due to the stability that is provided to the pots by the positioning structures (see below) the height of (the upstanding side walls 211 and 215 of) the carrier 200 may be lower than in traditional trays for plant pots, or even be left out altogether. Thus material and weight are saved.

The shown carrier for the assembly thus comprises a positioning structure comprising one or more protrusions, in particular one or more protrusions that extend substantially in a vertical direction in normal use with a non-circular shape in cross section, to be received at least partly into hole(s) of pots to define a single relative orientation of the pot and the carrier.

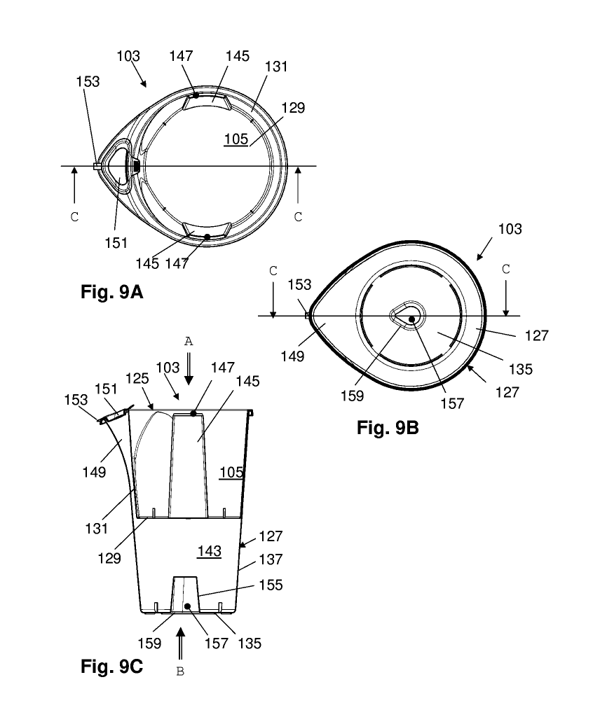

In particular referring to FIGS. 9A-9C applies that the shown pots 103 each form a plant pot assembly, similar to that of FIGS. 6A-6C, comprising an inner pot 125 and an outer pot 127. The inner pot 125 has a bottom 129 and a side wall 131 which surround the interior space 105 for receiving a plant in a growing medium, and a top edge 133. The outer pot 127 has a bottom 135 and a side wall 137 which surround an inner space 141 so that underneath the bottom 129 of the inner pot 125 a liquid reservoir 143 is formed. Between the inner and outer pots 125, 127, further (two) channels 145 are formed through which wicks (not shown) can run to transport liquid from the reservoir 143 to the growing medium in the interior space 105 to moisten the medium and feed one or more plants therein. The inner pot 125 is substantially circular in cross section. With a relatively acute portion the outer pot 127 forms a filling channel 149 that extends from the spout 107 along the inner pot 125 so that the reservoir 143 may be filled. The spout 107 is closable with a cap 151, which here is connected by a hinge 153 to the inner pot 125 which grips around the outer pot 131.

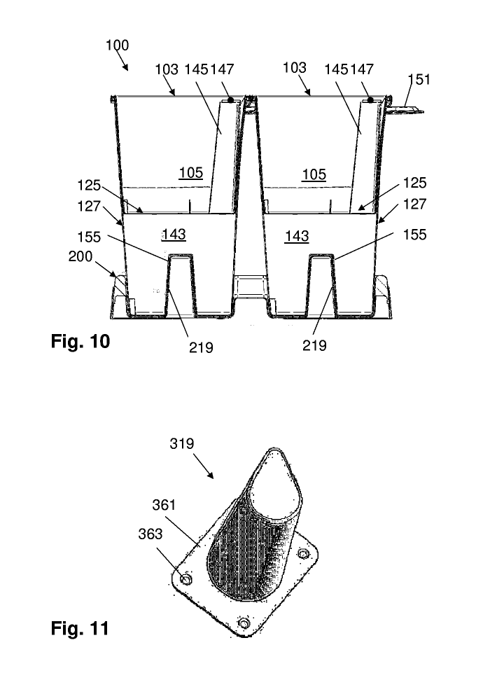

In the bottom 135 of the outer pot 127 a kick 155 is formed that provides a recessed hole 157 with an entrance opening 159. The hole 157 has an internal shape which substantially corresponds with the external shape of the protrusion 19 of the carrier 200 (FIG. 4), however here the protrusion 219 and the hole 157 are relatively higher, so that the protrusion 219 extends above the top wall 209 of the carrier 200 (see FIG. 10).

The drop shape of the hole 157 and the drop shape of the top side of the (outer side of the) pot 103 point in the shown embodiment substantially in the same direction (FIG. 6C). The bottom 135 and the walls 137 of the outer pot 127 on the one hand and (the walls 15 and the bottom 17 of) the holes 13 on the other hand also have a corresponding shape. Thus the pot 103 may be placed fittingly into a hole 213 of the carrier 200 wherein the protrusion 219 is received fittingly into the hole 157 of the pot. The corresponding non-circular shapes of the protrusion 219 and the hole 157 define hereby a single relative orientation of the pot 103 relative to the carrier 200, despite the round outer shape of the underside of the outer pot 127. Since all protrusions 219 of the carrier 200 point in the same direction, an assembly of the carrier 200 with a number of pots 103, as shown in FIGS. 7 and 10, a pleasing uniform appearance, which may provide a consumer interest increasing effect to a display.

Due to the shape of the entrance opening 159 and the protrusion 219, the pot 103 cannot be placed on the protrusion 219 in an undesired orientation, but it can be so with a (small) rotation, wherein a lead-in is formed so that the placement of the pot 103 on the carrier 200 is easy and self-seeking.

It will be clear to the skilled person that a single plant pot without an inner pot and/or with a round or rectangular shape in top view may also be provided with the shown positioning structure, or another, without detracting from the functionality of the positioning structures and/or the pot as such.

FIG. 11 shows an embodiment of a positioning structure 319 in the shape of a cam 319 with a substantially equal shape as the protrusions 219 of the carrier 200 described before. The cam 319 is provided with an optional flange 361 with through holes 363, for attachment of the cam 319 on a support, e.g. a transport cart, a shelf or another object, e.g. by means of screws etc. Thus also without carrier 200 a desired display may be achieved with the pots 103 described above. The cam 319 may be attached releasably to a carrier so that varying displays are possible with an otherwise usable carrier. The cam 319 may be (partly) hollow or massive and/or have other fastening portions than the shown flange 361, e.g. an internal screw thread for attachment from below, which may give a quieter appearance of a respective carrier provided with a number of cams 319 without pots 103. A flange 361 and/or a cam 319 that is attachable from below can provide a flat bottom for (further) stability of a pot 103 placed on the cam 319.

Similar to FIGS. 7-10, a carrier 200 for an arrangement of pots according to FIG. 4 may be provided, wherein the hinges 53 arranged towards each other. Note that by suitable positioning and/or orientation possible delicate portions may be relatively protected.

The nature of the present disclosure is not restricted to the above described embodiments which can be varied in a number of ways within the scope of the claims, but is defined by the scope and spirit of the claims.

For instance, the first and second pots may be larger, smaller and/or formed different, e.g. higher or lower. They may be earthenware, glass, plastic or another material.

The assembly may comprise more than one wick. A wick may be surrounded by a sleeve. The wick material may comprise glass fibre and/or cotton fibre or another material, and it can have a sponge-like character. A suitable material may comprise polymer material and/or hollow fibers. It has appeared that spongiform and/or wicks woven straight with respect to their length direction generally perform poorly due to either a too high or a too low capillary power, which leads to drowning or rather drying of the plant. A wick comprising bundles of hollow fibres that are loosely woven with relatively closely arranged material extending in the direction of elongation of the wick and held together by relatively far separated transverse weft is suitable. A wick of braided or diagonally woven material, with threads or bundles of filaments at a diagonal angle with the length direction of the wick, e.g. an angle between about 30 and 60 degrees with the length direction of the wick, proved particularly suitable. It is suspected that due to the diagonal direction of the wick threads an evenly distributed capillary action with always a direction component in the direction of elongation of the wick and the transport direction for the liquid is provided, which is not interrupted by a structure perpendicular to the wick, such as perpendicular weft threads and/or a rim of the first pot.

The assembly may be provided with a sleeve to provide it with an attractive appearance, and/or be provided with one or more supports for flowers or plants, e.g. climbing plants.

The assembly may be arranged for and/or provided with more than one plant. The plant may be a chamber plant or an outside plant and need not be a flowering plant.

An assembly of a pot and a carrier can be used with single pots instead of pot assemblies. The pots may be larger, smaller and/or formed different, e.g. higher or lower. They may be of crockery, glass, plastic or another material. A carrier may (be arranged to) comprise more or less pots.

Options and aspects of different embodiments may be exchanged and combined, unless stated otherwise.

1. A plant pot assembly comprising a first pot with an interior space for receiving therein a plant in soil or in another growing medium,
a second pot coupled to the first pot and having an interior space for forming a liquid reservoir, and
a wick which extends from the liquid reservoir to within the interior space of the first pot for transporting liquid from the liquid reservoir into the interior space of the first pot,
wherein the liquid reservoir has a filling opening at or near the upper side of the assembly and wherein the first pot is received in the second pot with a close fit so that the liquid reservoir is situated substantially below the first pot, at least substantially below the interior space thereof, and is connected with the filling opening via a filling channel
wherein the wick extends between the first and second pots and protrudes along or near an upper edge of the first pot into the interior space of the first pot, e.g. through an opening in a wall of the first pot, and
wherein the first pot is substantially watertight and the assembly is arranged to prevent liquid transport between the reservoir and the growing medium via another route than the wick.

2. The assembly of claim 1, wherein the wick is arranged in the interior space of the first pot in an upper portion of it.

3. The assembly of claim 1, wherein the first pot is substantially fully received in the second pot.

4. The assembly of claim 1, wherein the first pot and the second pot are releasably coupled.

5. The assembly of claim 1, wherein the first and second pots are coupled by an at least partly tight fit of the pots and at least one of the first and second pots is provided with a closure and/or lid.

6. The assembly of claim 1, wherein the side walls of the first and second pots touch each other at least partly and support each other, wherein preferably the side walls touch each other over the major part, such as e.g. 75% or more of the surface of the side walls of the first pot.

7. The assembly of claim 1, wherein the assembly is arranged to give a signal to a user when the reservoir is filled over a particular level.

8. The assembly of claim 1, wherein at least the first pot or the second pot comprises an ornamental pot.

9. The assembly of claim 1, further comprising growing material and a plant.

10. The assembly of claim 9, wherein the reservoir (15) is arranged to contain sufficient liquid and possibly nutrients and/or dunging substances to let the plant survive a particular period.

11. The assembly of claim 1, wherein the wick comprises a braided or diagonally woven material with respect to the length direction of the wick.

12. The assembly of claim 11, wherein the wick is constructed from threads and/or filaments that run at an angle between ca 30 and 60 degrees with the direction of elongation of the wick.

13. The assembly of claim 1, wherein the wick is constructed from polymeric hollow-fibers.

14. The assembly of claim 1, wherein at least the second pot is substantially round or drop-shaped in top view with a relative sharp side and a relatively blunt side, wherein the relatively sharp side comprises a funnel that is arranged within a circumscribed rectangle, preferably a circumscribed square, about the round or blunt side.

15. The assembly of claim 1, provided with a carrier for one or more assemblies, wherein the assembly and the carrier are provided with cooperating positioning structures for defining a mutual relative position.

16. Assembly according of claim 15, wherein the cooperating positioning structures extend substantially in a vertical direction in normal use.

17. The assembly of claim 15, wherein a first one of the cooperating positioning structures comprises one or more holes, in particular one or more holes with a non-circular shape, and a second of the cooperating positioning structure comprises one or more protrusions to be received at least partly in the hole(s), and wherein preferably the hole is provided in the bottom of the pot and the carrier is provided with the one or more protrusions.

18. The assembly of claim 17, wherein the one or more holes and/or one or more protrusions are formed at least partly conical with upwards decreasing size.

19. The assembly of claim 17, wherein the carrier has a space for receiving therein at least partly the pot and supporting the pot, preferably more spaces for receiving more pots, wherein the space(s) comprise(s) one of the first and second positioning structures, and wherein in the space(s) one or more protrusions are arranged, preferably a single protrusion per space, for instance in or near a middle of the space, wherein the space has a top side and a bottom and a depth with respect to the top side, and at least one of the protrusions extends from the bottom up to the top side of the space or near that, preferably above that.

20. The assembly of claim 15, wherein at least one of the cooperating positioning structures is releasably attached to a substrate.
